(19) United States
(12) Patent Application Publication
(10) Pub. No.: US 2022/0171169 A1
(43) Pub. Date: Jun. 2, 2022

(54) PROJECTION OPTICAL SYSTEM

(71) Applicant: SUN YANG OPTICS DEVELOPMENT CO., LTD., TAOYUAN CITY (TW)

(72) Inventors: SHENG-CHE WU, TAOYUAN CITY (TW); YU-HUNG CHOU, TAOYUAN CITY (TW); WEI-HAO HUANG, TAOYUAN CITY (TW)

(21) Appl. No.: 17/106,747

(22) Filed: Nov. 30, 2020

(51) Int. Cl. G02B 13/16; G02B 13/18; G03B 21/28

(52) U.S. Cl. CPC G02B 13/16; G03B 21/28; G02B 13/18

(57) ABSTRACT

A projection optical system, comprising: an image source; a lens group; a reflector; an image and an aperture, the lens group and the reflector form multiple optical paths between the image and image source, each optical path has a chief ray and a marginal ray, the chief ray of one of the optical paths forms a chief ray of a paraxial image height at the part where image source be near to the optical axis, the chief ray of another one of the optical paths forms a marginal ray of an off-axis image height at the part where image source be far from the optical axis; whereby forming a first point and a second point, the first point located at the origin and the second point is located in the first quadrant, and forming a third point and a fourth point, the third point located at the fourth quadrant and the fourth point is located in the second quadrant.

### BACKGROUND OF THE INVENTION

### 1. Field of the Invention

The present invention relates to a projection optical system, particularly to one that has an image source, a lens group, an aperture, a reflector, an image, a first quadrant, a second quadrant, a third quadrant and a fourth quadrant of rectangular coordinates.

### 2. Description of the Related Art

Projectors have been innovated with latest technology for the past years, ranging from projectors with normal focal lengths to ones with short focal lengths. They can be applied in many aspects like multimedia presentations, television projection, family cinemas, teleconferences, etc. In recent years, projectors with short focal lengths are mainly applied in educational fields and are favorable in small families.

In view of the quality of the projected images, the longer the focal lengths are, the narrower the angle of the field of view the projectors have, and as the focal lengths become shorter, the distortion of the images gets worse. So it is impossible to guarantee the quality of the images with the focal lengths reduced. Therefore, it is desirable to make an arrangement of the structures of the projectors to achieve greater efficiency in projections while ensuring the quality of the projected images.

### SUMMARY OF THE INVENTION

A primary objective of the present invention is to provide a projection optical system which has an image source, a lens group, an aperture, a reflector, an image, a first quadrant, a second quadrant, a third quadrant and a fourth quadrant of rectangular coordinates that make the image source lead the optical path effectively and meanwhile provide images with better quality.

Another objective of the present invention is to provide a projection optical system that has a front group lens and a rear group lens operated correspondingly to enhance quality of the images and reduce the manufacture cost.

Yet another objective of the present invention is to provide a projection optical system that make the width of the image and the project distance of the image operated correspondingly to enhance quality of the images and make the project ratio smaller.

To achieve the objects mentioned above, the present invention comprises an image source; a lens group arranged at the lateral side of the image source; a reflector arranged at the lateral side of the lens group; an image, the lens group and the reflector form multiple optical paths between the image and image source, each optical path has a chief ray and a marginal ray; and an aperture arranged inside the lens group and the center of the aperture is defined as an origin, define the axial direction as X axis and the radial direction as Y axis to form a rectangular coordinate system, the rectangular coordinate system has a first quadrant, a second quadrant, a third quadrant, a fourth quadrant, and the projection optical system has an optical axis which coincided with the X axis making the chief ray of one of the optical paths forms a chief ray of a paraxial image height at the part where image source be near to the optical axis, the chief ray of another one of the optical paths forms a marginal ray of an off-axis image height at the part where image source be far from the optical axis; whereby when the image source and the image are located in the second quadrant and the reflector is located in the fourth quadrant, the chief ray of the paraxial image height intersect withs the chief ray of the off-axis image height intersect, then sequentially forming a first point and a second point, the first point located at the origin and the second point is located in the first quadrant, and the chef ray of the optical path intersects with the marginal ray of the optical path, and sequentially forming a third point and a fourth point, the third point located at the fourth quadrant and the fourth point is located in the second quadrant.

Furthermore, the lens group can be divided into a front group lens and a rear group lens, the front group lens is close to the reflector side, and the rear group lens is close to the image source side, the distance between the front group lens and the rear group lens is the longest lens distance in the lens group.

Also, the front group lens includes at least two aspheric lens, and at least one of the aspheric lens is a negative lens.

Also, the rear group lens includes at least two doublet and an aspheric lens, the aspheric lens can be a double-sided aspheric independent lens, or the aspheric lens can be one side aspheric and one spherical, the aspheric lens and the spherical can be bonding to form a doublet.

Also, the Abbe number of the last lens of the rear group lens is 17-24 and is close to the image source side.

Also, the focal length of the reflector is F1 and the focal length of the lens group is F2, and the projection optical system meets the 11.5<F1/F2<3.2.

Also, the width of the image is set as W and the project distance from the reflector to the image is set as T, and conforms to the conditional formula of the projection ratio of the projection optical system: T/W<0.275.

Also, the F value of the projection optical system is 1.6-3.2.

Also, the displacement of the center point of the image source corresponding to the optical axis is define as d, and short side of the image source is defined as h, and fits the condition: 2d/h>120%.

Also, taking the image source as the base point as a reference to get locations of the upper point, the lower point, the left point, the right point, an upper left point, the upper right point, the lower left point and the lower right point, at the boundary of the image source, and when the image source is above the optical axis, at the midpoint position between the lens group and the reflector, the chief ray of each optical path forms a chief ray of the central optical path, a chief ray of the upper optical path, a chief ray of the lower optical path, a chief ray of the left optical path, a chief ray of the right optical path, a chief ray of the upper left optical path, a chief ray of the upper right optical path, a chief ray of the lower left optical path, a chief ray of the lower right optical path, and the up and down component of the distance from the chief ray of the central optical path to the optical axis is set as X₂, and the up and down component of the distance from the chief ray of the upper optical path to the optical axis is set as X₃, the up and down component of the distance from the chief ray of the lower optical path to the optical axis is set as X₁, the up and down component of the distance from the chief ray of the left optical path to the optical axis is set as Y₂, the up and down component of the distance from the chief ray of the right optical path to the optical axis is set as Y₂, the up and down component of the distance from the chief ray of the upper left optical path to the optical axis is set as Y₃, the up and down component of the distance from the chief ray of the upper right optical path to the optical axis is set as Y₃, the up and down component of the distance from the chief ray of the lower left optical path to the optical axis is set as Y₁, the up and down component of the distance from the chief ray of the lower right optical path to the optical axis is set as Y₁, and meet the following conditions: 0.9*|Y1|≤X1|≤1.2*|Y1|; |X2|>|Y2|; |X3|>|Y3|.

Also, between the reflector and the image include at least an optical element for deflecting the optical path or correcting aberrations.

With the feature disclosed above, the present invention uses the image source, the lens group, the aperture, the reflector, the image, operated correspondingly with the first quadrant, the second quadrant, the third quadrant and the fourth quadrant of rectangular coordinates, and the front group lens and the rear group lens operated correspondingly, and the width of the image and the project distance of the image operated correspondingly to make the image source lead the optical path effectively, reduce the manufacture cost, make the project ratio smaller, and make the F value of the projection optical system smaller to be able to install with large aperture so as to enhance quality of the images.

### BRIEF DESCRIPTION OF THE DRAWINGS

FIG. 1A is a schematic diagram illustrating lenses arrangement of the first embodiment the present invention;

FIG. 1B is a schematic diagram illustrating a travel path of optical path of the first embodiment the present invention;

FIG. 1C is a schematic diagram illustrating the forming of the image of the first embodiment the present invention;

FIG. 1D is the zoom in of the 1D in the FIG. 1C;

FIG. 1E is the zoom in of the 1E in the FIG. 1C;

FIG. 1F is a schematic plan view of the IMA in the FIG. 1B;

FIG. 1G is a schematic plan view of the G-G in the FIG. 1B;

FIG. 1H is a schematic diagram illustrating the optical path of maxima image height which divided into ten equal of the first embodiment;

FIG. 1I is a graph illustrating the lateral image light of 0.5830 mm image height of the image source of the first embodiment;

FIG. 1J is a graph illustrating the lateral image light of 0.8710 mm image height of the image source of the first embodiment;

FIG. 1K is a graph illustrating the lateral image light of 1.7420 mm image height of the image source of the first embodiment;

FIG. 1L is a graph illustrating the lateral image light of 2.6130 mm image height of the image source of the first embodiment;

FIG. 1M is a graph illustrating the lateral image light of 3.4840 mm image height of the image source of the first embodiment;

FIG. 1N is a graph lateral image light of 4.3550 mm image height of the image source of the first embodiment;

FIG. 1O is a graph illustrating the field curvature of the first embodiment;

FIG. 1P is a graph illustrating the distortion of the first embodiment;

FIG. 1Q is a graph illustrating the lateral color aberration of the first embodiment;

FIG. 1R is a graph illustrating the vertical aberration of the first embodiment;

FIG. 1S is schematic diagram illustrating the optical elements of the first embodiment;

FIG. 2A is a schematic diagram illustrating lenses arrangement of the second embodiment the present invention;

FIG. 2B is a schematic diagram illustrating a travel path of optical path of the second embodiment the present invention;

FIG. 2C is a schematic diagram illustrating the optical path of maxima image height which divided into ten equal of the second embodiment;

FIG. 3A is a schematic diagram illustrating lenses arrangement of the third embodiment the present invention;

FIG. 3B is a schematic diagram illustrating a travel path of optical path of the third embodiment the present invention;

FIG. 3C is a schematic diagram illustrating the optical path of maxima image height which divided into ten equal of the third embodiment;

FIG. 4A is a schematic diagram illustrating lenses arrangement of the fourth embodiment the present invention;

FIG. 4B is a schematic diagram illustrating a travel path of optical path of the fourth embodiment the present invention;

FIG. 4C is a schematic diagram illustrating the optical path of maxima image height which divided into ten equal of the fourth embodiment;

FIG. 5A is a schematic diagram illustrating lenses arrangement of the fifth embodiment the present invention;

FIG. 5B is a schematic diagram illustrating a travel path of optical path of the fifth embodiment the present invention;

FIG. 5C is a schematic diagram illustrating the optical path of maxima image height which divided into ten equal of the fifth embodiment.

### DETAILED DESCRIPTION OF THE PREFERRED EMBODIMENT

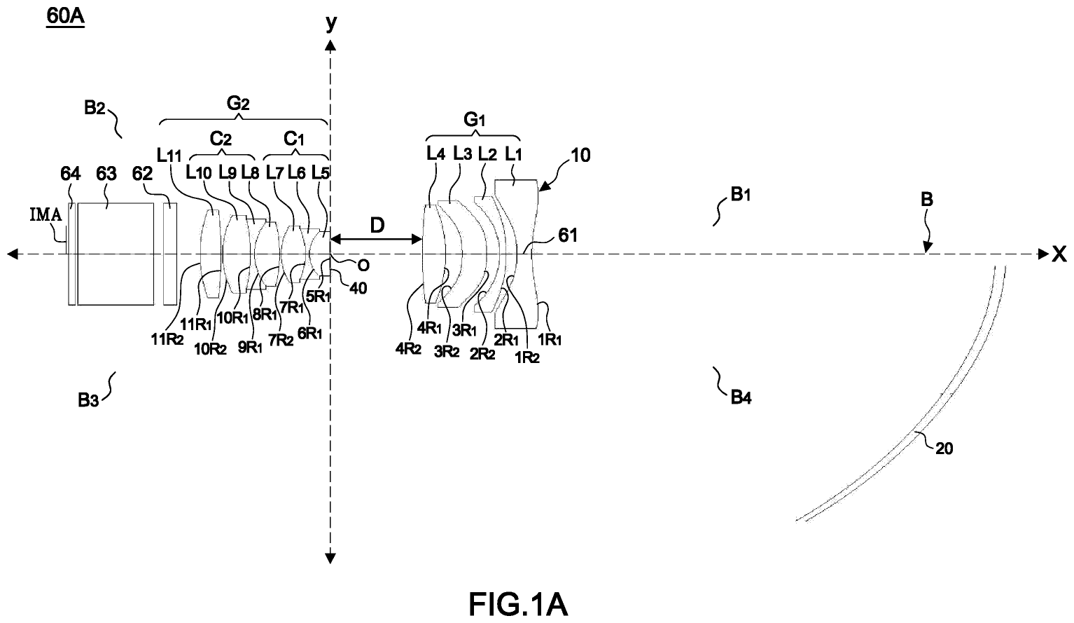

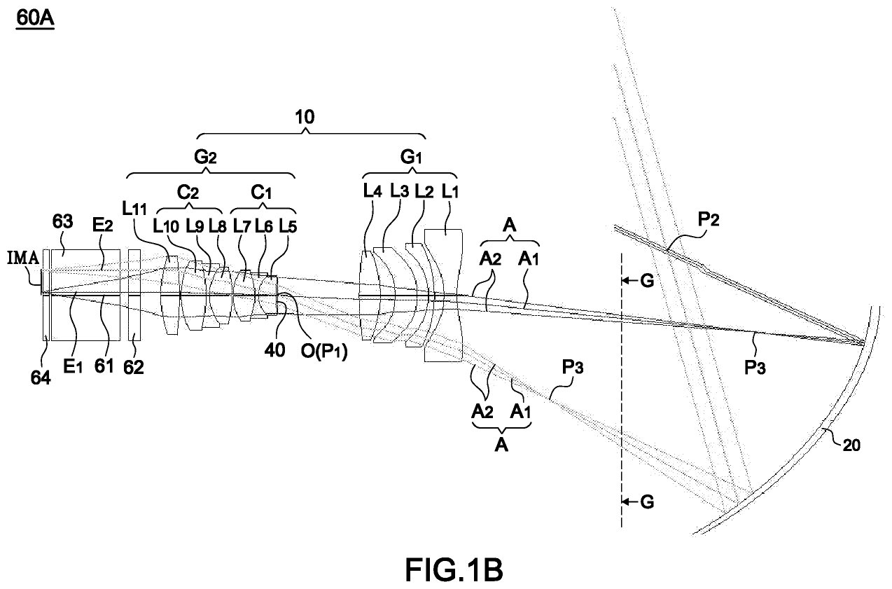

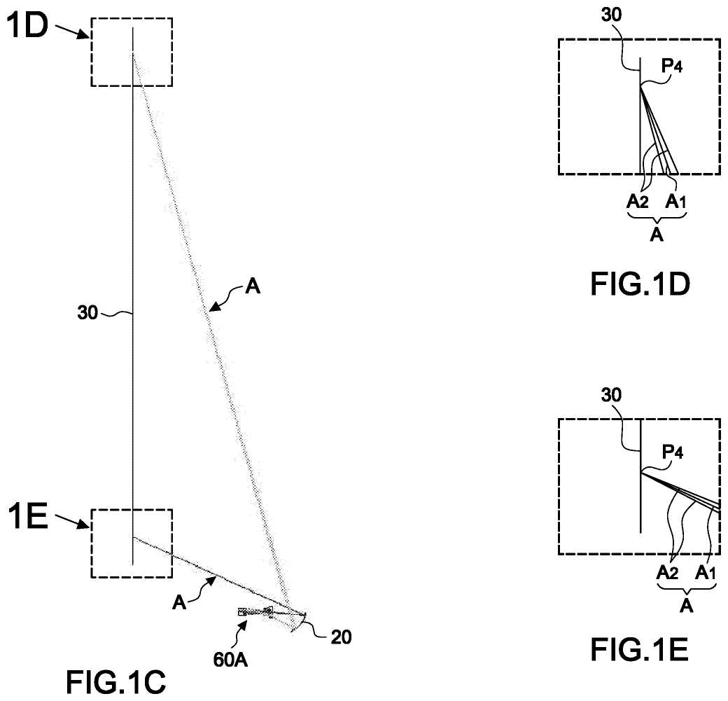

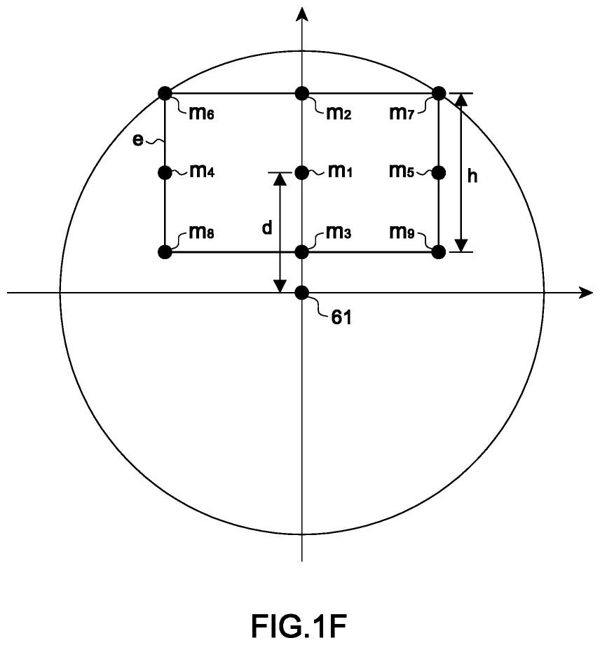

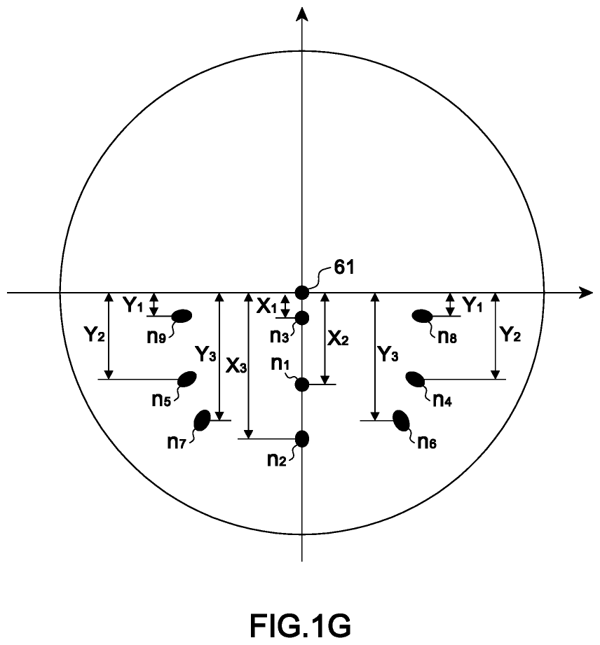

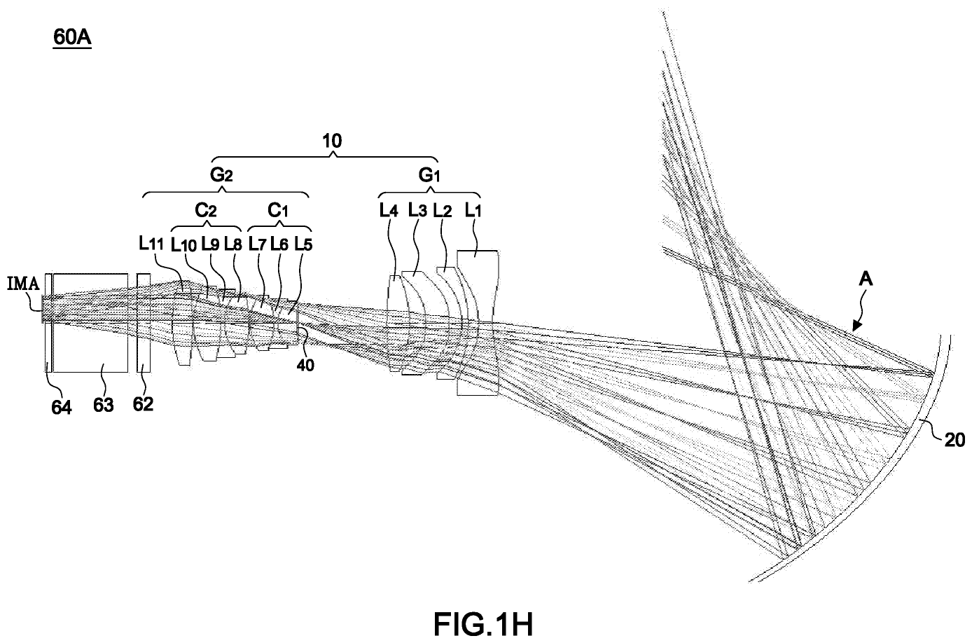

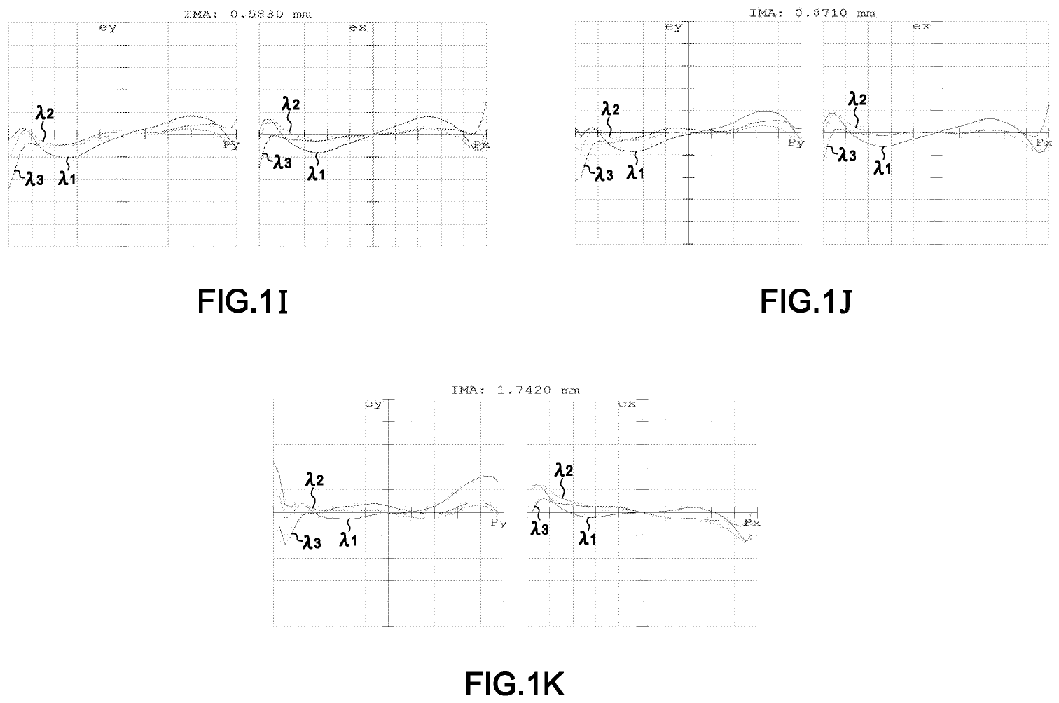

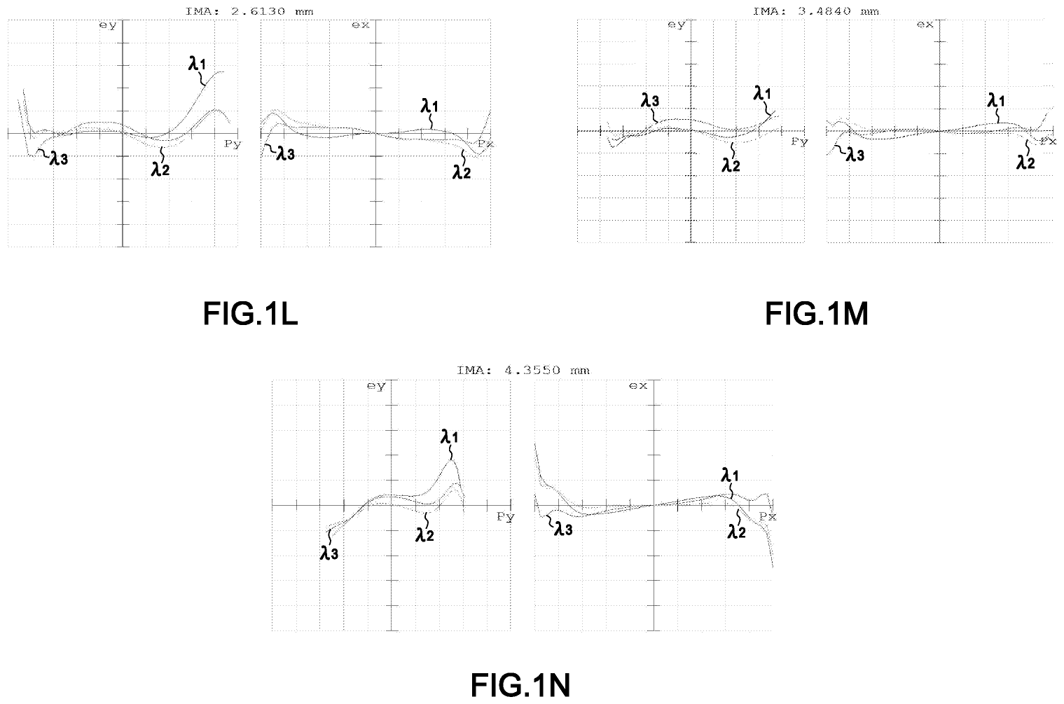

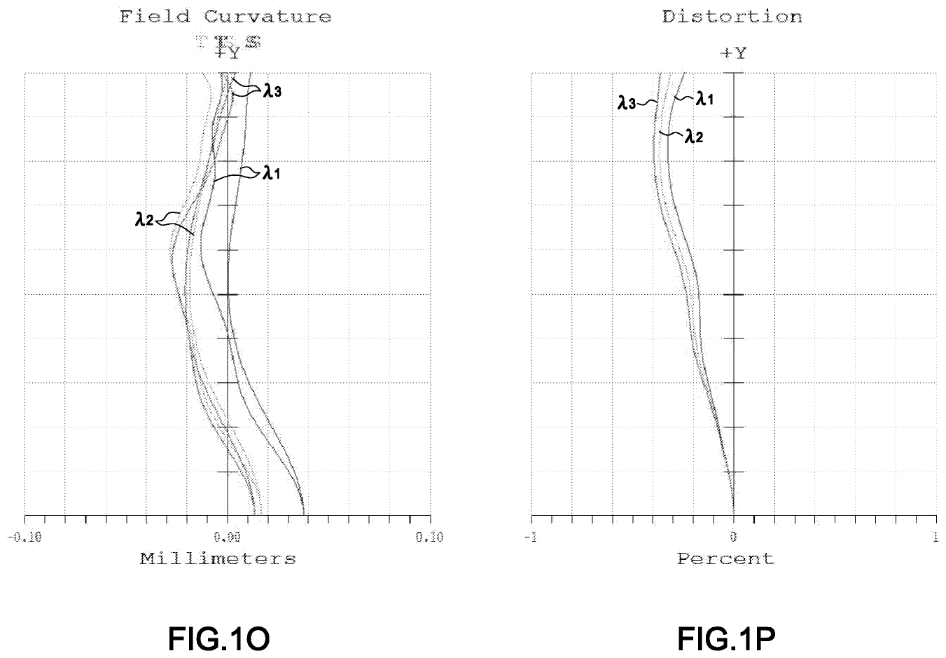

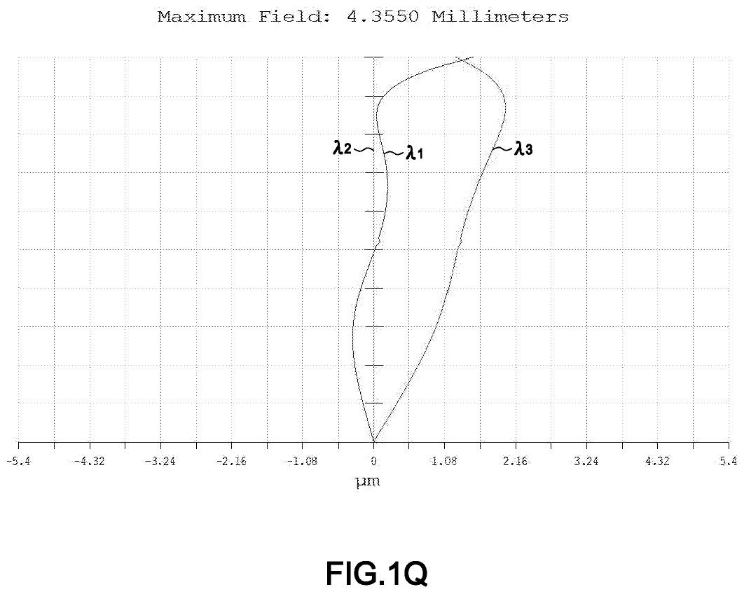

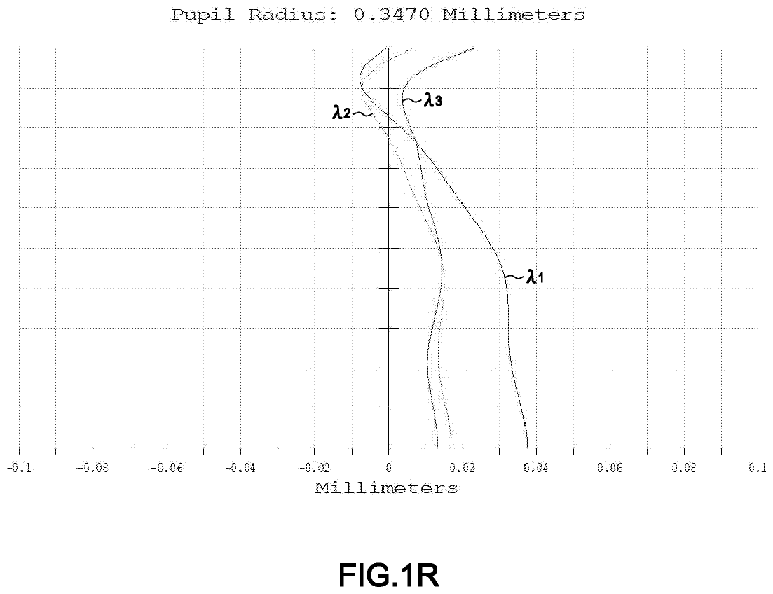

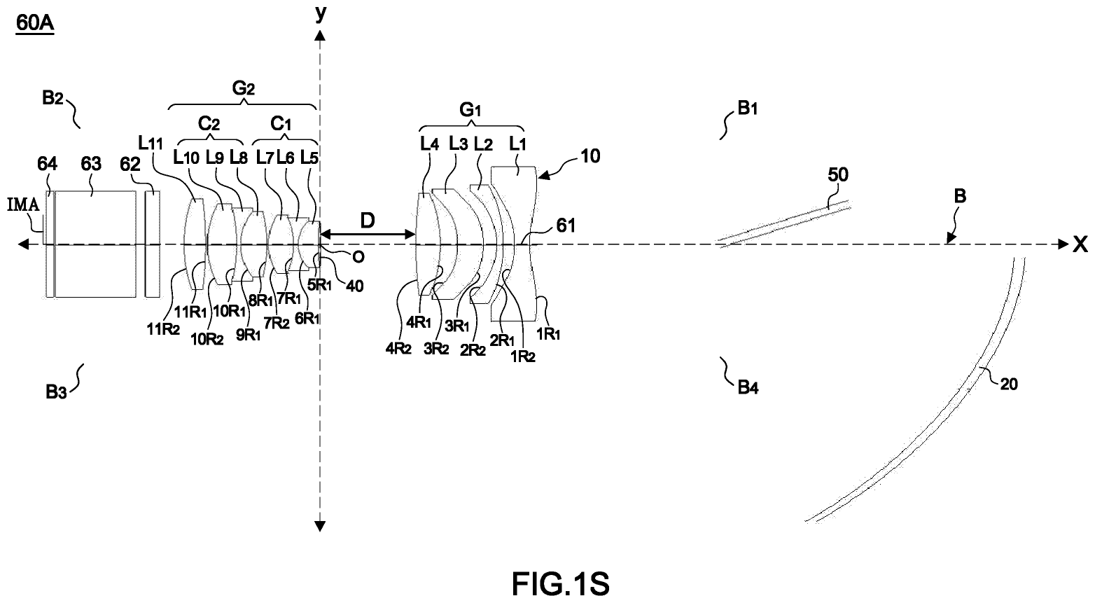

Referring to FIGS. 1A-1S, a projection optical system 60A of the first embodiment of the present invention mainly comprises a projection optical system image source IMA, in this embodiment, the image source IMA can be coordinate with a transmissive smooth picture actuator 62, a prism 63, a cover glass 64, but the present invention is not limited to such application.

A lens group 10 arranged at the lateral side of the image source IMA; a reflector 20 arranged at the lateral side of the lens group 10; an image 30, the lens group 10 and the reflector 20 form multiple optical paths A between the image 30 and image source IMA, each optical path A has a chief ray A₁ and a marginal ray A₂.

Moreover, the lens group 10 can be divided into a front group lens G₁ and a rear group lens G₂, the front group lens G₁ is close to the reflector 20 side, and the rear group lens G₂ is close to the image source side IMA, the distance between the front group lens G₁ and the rear group lens G₂ is the longest lens distance in the lens group 10, but the present invention is not limited to such application.

Also, the front group lens G₁ includes at least two aspheric lens, and at least one of the aspheric lens is a negative lens; the rear group lens G₂ includes at least two doublet and an aspheric lens, the aspheric lens can be a double-sided aspheric independent lens, or the aspheric lens can be one side aspheric and one spherical, the aspheric lens and the spherical can be bonding to form a doublet; the Abbe number of the last lens of the rear group lens G₂ is 17-24 and is close to the image source side, but the present invention is not limited to such application.

Referring to the FIG. 1A, Table 1 and Table 2, the projection optical system 60A of the first embodiment has the front group lens G₁ includes a first lens L₁, a second lens L₂, a third lens L₃ and a fourth lens L₄, the first lens L₁ and the third lens L₃ are aspheric lens; the two doublet of the rear group lens G₂ are formed by bonding a fifth lens L₅ and a sixth lens L₆ to form a first doublet C₁, and by bonding an eighth lens L₈, a ninth lens L₉ and a tenth lens L₁₀ to form a second doublet C₂, and the seventh lens L₇ are aspheric lens, the seventh lens L₇ can also be an independent lens, or the seventh lens L₇ can be bonded with the sixth lens L₆ to make the fifth lens L₅, the sixth lens L₆ and the seventh lens L₇ form a first doublet C₁; the eleventh lens L₁₁ is the last lens, but the present invention is not limited to such application.

TABLE 1

| | | | Refractive | Abbe |
|---|---|---|---|---|
| | | | index | Number |
| Surface | Radius(mm) | Thickness(mm) | (Nd) | (Vd) |
| (MIRROR) | 29.52 | 69.90 | | |
| 1R₁ | −18.35 | 2.20 | 1.53 | 56.28 |
| 1R₂ | 15.54 | 1.60 | | |
| 2R₁ | 19.81 | 1.00 | 1.73 | 54.67 |
| 2R₂ | 10.47 | 1.96 | | |
| 3R₁ | 19.18 | 3.68 | 1.53 | 56.28 |
| 3R₂ | 14.91 | 2.52 | | |
| 4R₁ | 19.93 | 3.50 | 1.85 | 23.79 |
| 4R₂ | −63.08 | 13.82 | | |
| (APERTURE) | INF | 0.20 | | |
| 5R₁ | −53.47 | 3.00 | 1.70 | 41.14 |
| 6R₁ | −4.82 | 0.60 | 1.80 | 46.57 |
| 7R₁ | 10.00 | 3.66 | 1.52 | 64.07 |
| 7R₂ | −8.76 | 0.20 | | |
| 8R₁ | 19.93 | 3.80 | 1.50 | 81.59 |
| 9R₁ | −8.18 | 0.60 | 1.85 | 23.79 |
| 10R₁ | 23.61 | 4.23 | 1.50 | 81.59 |
| 10R₂ | −12.99 | 0.20 | | |
| 11R₁ | 55.19 | 3.18 | 1.92 | 18.90 |
| 11R₂ | −20.91 | 3.50 | | |

TABLE 2

| ASPH | MIRROR | 1R₁ | 1R₂ | 3R₁ | 3R₂ | 7R₁ | 7R₂ |
|---|---|---|---|---|---|---|---|
| Radius | 29.52 | −18.35 | 15.54 | 19.18 | 14.91 | 10.00 | −8.76 |
| Conic | −1.12 | 0.00 | 1.34 | 0.00 | 0.00 | 0.00 | 2.09 |
| 4TH | −1.34E−06 | 3.14E−04 | 5.16E−04 | 1.50E−03 | 1.07E−03 | 0.00E+00 | 3.54E−04 |
| 6TH | 2.27E−09 | −2.38E−06 | −6.26E−06 | −2.99E−05 | −2.04E−05 | 0.00E+00 | −6.11E−06 |
| 8TH | −1.74E−12 | 2.32E−08 | −2.49E−07 | 5.03E−07 | 6.66E−07 | 0.00E+00 | 4.03E−06 |
| 10th | 1.13E−15 | −1.78E−10 | 7.85E−09 | −7.50E−09 | −2.16E−08 | 0.00E+00 | −5.30E−07 |
| 12th | −4.24E−19 | 1.02E−12 | −1.05E−10 | 6.76E−11 | 3.77E−10 | 0.00E+00 | 4.14E−08 |
| 14th | 7.24E−23 | −3.72E−15 | 7.19E−13 | −2.79E−13 | −3.34E−12 | 0.00E+00 | −1.64E−09 |
| 16th | 0.00E+00 | 6.49E−18 | −2.09E−15 | 2.69E−16 | 1.21E−14 | 0.00E+00 | 2.74E−11 |

An aperture 40 arranged inside the lens group 10 and the center of the aperture 40 is defined as an origin O, define the axial direction as X axis X and the radial direction as Y axis Y to form a rectangular coordinate system B, the rectangular coordinate system B has a first quadrant B₁, a second quadrant B₂, a third quadrant B₃ and a fourth quadrant B₄, and the projection optical system 60A has an optical axis 61 which coincided with the X axis X making the chief ray A₁ of one of the optical paths A forms a chief ray A₁ of a paraxial image height E₁ at the part where image source IMA be near to the optical axis 61, the chief ray A₁ of another one of the optical paths A forms a marginal ray A₂ of an off-axis image height E₂ at the part where image source IMA be far from the optical axis 61.

Referring to FIGS. 1B-1E, when the image source IMA and the image 30 are located in the second quadrant B₂ and the reflector 20 is located in the fourth quadrant B₄, the chief ray A₁ of the paraxial image height E₁ intersect withs the chief ray A₁ of the off-axis image height E₂ intersect, then sequentially forming a first point P₁ and a second point P₂, the first point P₁ located at the origin O and the second point P₂ is located in the first quadrant B₁, and the chef ray A₁ of the optical path A intersects with the marginal ray A₂ of the optical path A, and sequentially forming a third point P₃ and a fourth point P₄, the third point P₃ located at the fourth quadrant B₄ and the fourth point P₄ is located in the second quadrant B₂.

Moreover, in this embodiment, the focal length of the reflector 20 is F1 and the focal length of the lens group 10 is F2, and the projection optical system meets the 11.5<F1/F2<3.2; the width of the image is set as W and the project distance from the reflector 20 to the image 30 is set as T, and conforms to the conditional formula of the projection ratio of the projection optical system: T/W<0.275; the F value of the projection optical system is 1.6-3.2. but the present invention is not limited to such application.

As FIG. 1F and FIG. 1G showing, the displacement of the center point of the image source IMA corresponding to the optical axis 61 is define as d, and short side of the image source IMA is defined as h, and fits the condition: 2d/h>120%, and take the center m₁ of the image source IMA as the base point as a reference to get locations of the upper point m₂, the lower point m₃, the left point m₄, the right point m₅, an upper left point m₆, the upper right point m₇, the lower left point m₈ and the lower right point m₉, at the boundary e of the image source IMA, and when the image source IMA is above the optical axis 61, at the midpoint position between the lens group 10 and the reflector 20, the chief ray A₁ of each optical path A forms a chief ray A₁ of the central optical path n₁, a chief ray A₁ of the upper optical path n₂, a chief ray A₁ of the lower optical path n₃, a chief ray A₁ of the left optical path n₄, a chief ray A₁ of the right optical path n₅, a chief ray A₁ of the upper left optical path n₆, a chief ray A₁ of the upper right optical path n₇, a chief ray A₁ of the lower left optical path n₈, a chief ray A₁ of the lower right optical path n₉, and the up and down component of the distance from the chief ray A₁ of the central optical path n₁ to the optical axis 61 is set as X₂, and the up and down component of the distance from the chief ray A₁ of the upper optical path n₂ to the optical axis 61 is set as X₃, the up and down component of the distance from the chief ray A₁ of the lower optical path n₃ to the optical axis 61 is set as X₁, the up and down component of the distance from the chief ray A₁ of the left optical path n₄ to the optical axis 61 is set as Y₂, the up and down component of the distance from the chief ray A₁ of the right optical path n₅ to the optical axis 61 is set as Y₂, the up and down component of the distance from the chief ray A₁ of the upper left optical path n₆ to the optical axis 61 is set as Y₃, the up and down component of the distance from the chief ray A₁ of the upper right optical path n₇ to the optical axis 61 is set as Y₃, the up and down component of the distance from the chief ray A₁ of the lower left optical path n₈ to the optical axis 61 is set as Y₁, the up and down component of the distance from the chief ray A₁ of the lower right optical path n₉ to the optical axis 61 is set as Y₁, and meet the following conditions: 0.9*|Y1|≤|X1|≤1.2*|Y1|; |X2|>|Y2|; |X3|>|Y3|. , but the present invention is not limited to such application. Furthermore, FIG. 1H is showing optical path of the image height be divided into ten equal, but the present invention is not limited to such application.

The projection optical system 60A set the first wave length λ₁, the second wave length λ₂, the third wave length λ₃ as 0.450 um, 0.540 um and 0.630 um, and each of them can simulate different graphs illustrating the lateral image light, FIG. 1I, FIG. 1J, FIG. 1K, FIG. 1L, FIG. 1M and FIG. 1N, and the same image source IMA can present different image height, 0.5830 mm, 0.8710 mm, 1.7420 mm, 2.6130 mm, 3.4840 mm, 4.3500 mm, and the mark ey, py, ex and px represents the lateral aberration of Y axis, the pupil distance of Y axis, the lateral aberration of X axis and the pupil distance of X axis, wherein the maximum scale the lateral aberration of Y axis and the lateral aberration of X are ±20.000 um, and the pupil distance of Y axis the pupil distance of X axis is a normalized ratio; The field curvature graph FIG. 1O and the distortion graph FIG. 1P has maximum field 4.355 mm; The lateral color aberration graph FIG. 1Q has maximum field 4.355 mm; The vertical aberration graph FIG. 1R has pupil radius 0.3470 mm, with the above simulation curve and data can prove the projection optical system 60A maintain good image quality. Furthermore, as FIG. 1S showing, between the reflector 20 and the image 30 include at least an optical element 50 for deflecting the optical path or correcting aberrations, but the present invention is not limited to such application.

The first to fifth embodiment are having the same features above mentioned, therefore, they are technically interrelated and belong to a broad concept of invention, conform to the principle of unity, the only difference is the front group lens G₁ and the second group lens G₂ are slightly different.

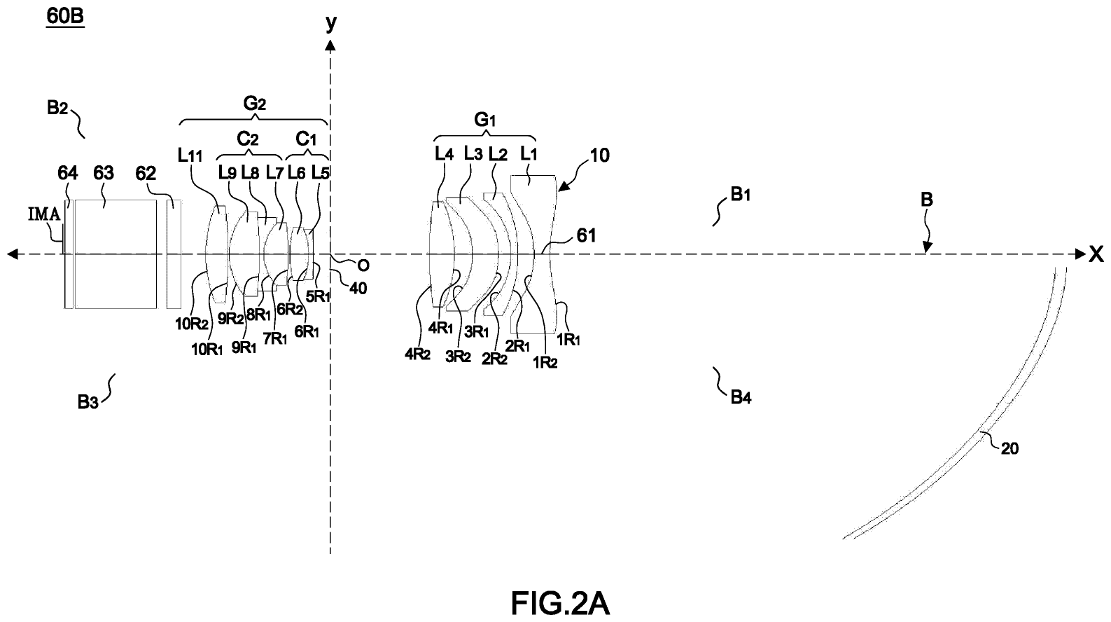

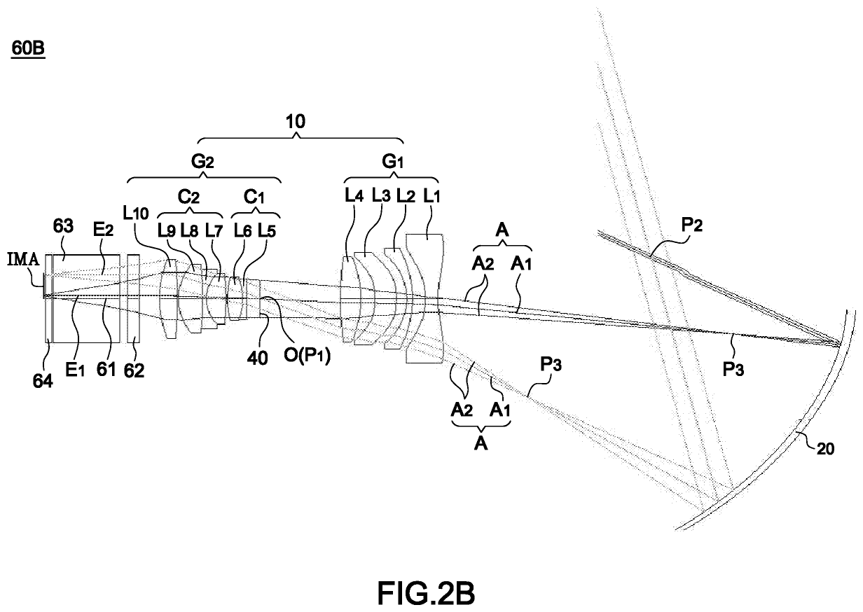

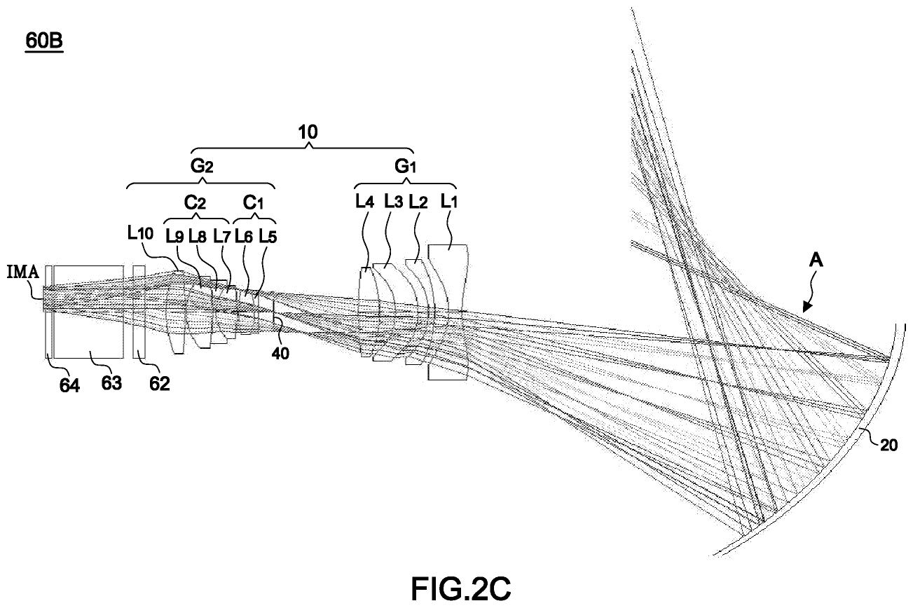

Referring to the FIGS. 2A-2C, Table 3 and Table 4, the projection optical system 60B of the second embodiment has the front group lens G₁ includes a first lens L₁, a second lens L₂, a third lens L₃ and a fourth lens L₄, the first lens L₁ and the third lens L₃ are aspheric lens; the two doublet of the rear group lens G₂ are formed by bonding a fifth lens L₅ and a sixth lens L₆ to form a first doublet C₁, and by bonding a seventh lens L₇, an eighth lens L₈ and ninth lens L₉ to form a second doublet C₂, and the sixth lens L₆ are aspheric lens; the tenth lens L₁₀ is the last lens, but the present invention is not limited to such application.

TABLE 3

| | | | Refractive | Abbe |
|---|---|---|---|---|
| | Radius | Thickness | index | number |
| Surface | (mm) | (mm) | (Nd) | (Vd) |
| (MIRROR) | 29.52 | 71.35 | | |
| 1R₁ | −18.35 | 2.20 | 1.53 | 56.28 |
| 1R₂ | 15.54 | 2.26 | | |
| 2R₁ | 19.81 | 1.00 | 1.73 | 54.67 |
| 2R₂ | 10.47 | 1.80 | | |
| 3R₁ | 19.18 | 3.68 | 1.53 | 56.28 |
| 3R₂ | 14.91 | 2.52 | | |
| 4R₁ | 19.93 | 3.50 | 1.85 | 23.79 |
| 4R₂ | −63.08 | 13.96 | | |
| (APERTURE) | INF | 2.45 | | |
| 5R₁ | 702.62 | 0.60 | 1.80 | 46.57 |
| 6R₁ | 9.59 | 2.70 | 1.52 | 64.07 |
| 6R₂ | −15.27 | 0.20 | | |
| 7R₁ | 34.80 | 3.45 | 1.50 | 81.59 |
| 8R₁ | −6.77 | 0.60 | 1.85 | 23.79 |
| 9R₁ | 50.59 | 4.28 | 1.50 | 81.59 |
| 9R₂ | −9.78 | 0.20 | | |
| 10R₁ | 75.14 | 3.10 | 1.92 | 18.90 |
| 10R₂ | −20.00 | 3.50 | | |

TABLE 4

| ASPH | MIRROR | 1R₁ | 1R₂ | 3R₁ | 3R₂ | 6R₁ | 6R₂ |
|---|---|---|---|---|---|---|---|
| Radius | 29.52 | −18.35 | 15.54 | 19.18 | 14.91 | 9.59 | −15.27 |
| Conic | −1.12 | 0.00 | 1.34 | 0.00 | 0.00 | 0.00 | 4.62 |
| 4TH | −1.34E−06 | 3.14E−04 | 5.16E−04 | 1.50E−03 | 1.07E−03 | 0.00E+00 | 2.64E−04 |
| 6TH | 2.27E−09 | −2.38E−06 | −6.26E−06 | −2.99E−05 | −2.04E−05 | 0.00E+00 | −2.73E−05 |
| 8TH | −1.74E−12 | 2.32E−08 | −2.49E−07 | 5.03E−07 | 6.66E−07 | 0.00E+00 | 9.16E−06 |
| 10th | 1.13E−15 | −1.78E−10 | 7.85E−09 | −7.50E−09 | −2.16E−08 | 0.00E+00 | −1.43E−06 |
| 12th | −4.24E−19 | 1.02E−12 | −1.05E−10 | 6.76E−11 | 3.77E−10 | 0.00E+00 | 1.19E−07 |
| 14th | 7.24E−23 | −3.72E−15 | 7.19E−13 | −2.79E−13 | −3.34E−12 | 0.00E+00 | −5.03E−09 |
| 16th | 0.00E+00 | 6.49E−18 | −2.09E−15 | 2.69E−16 | 1.21E−14 | 0.00E+00 | 8.51E−11 |

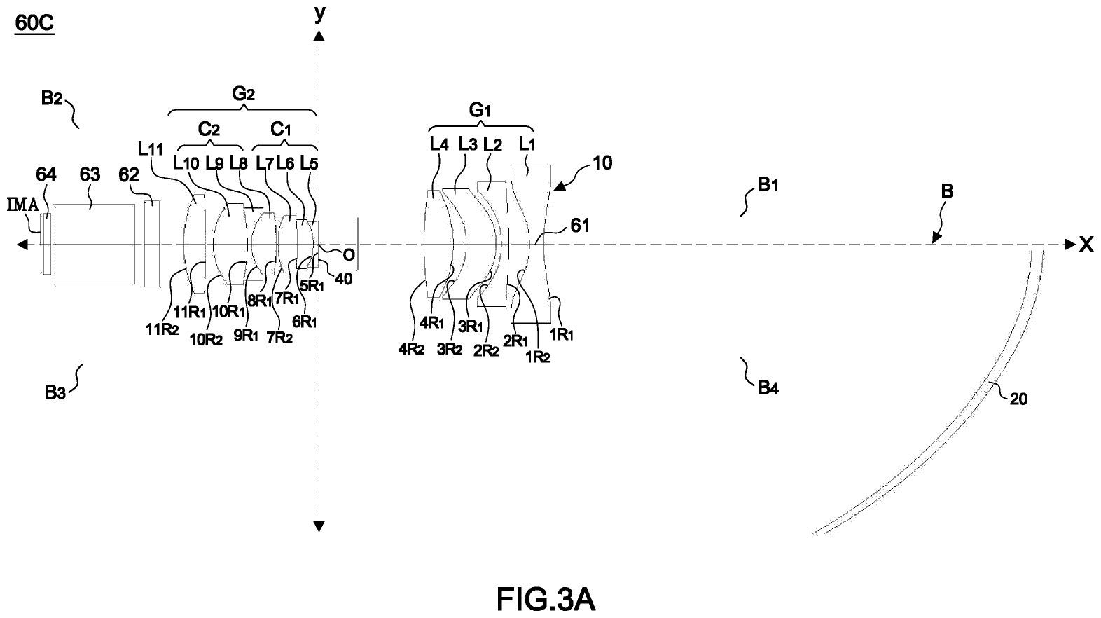

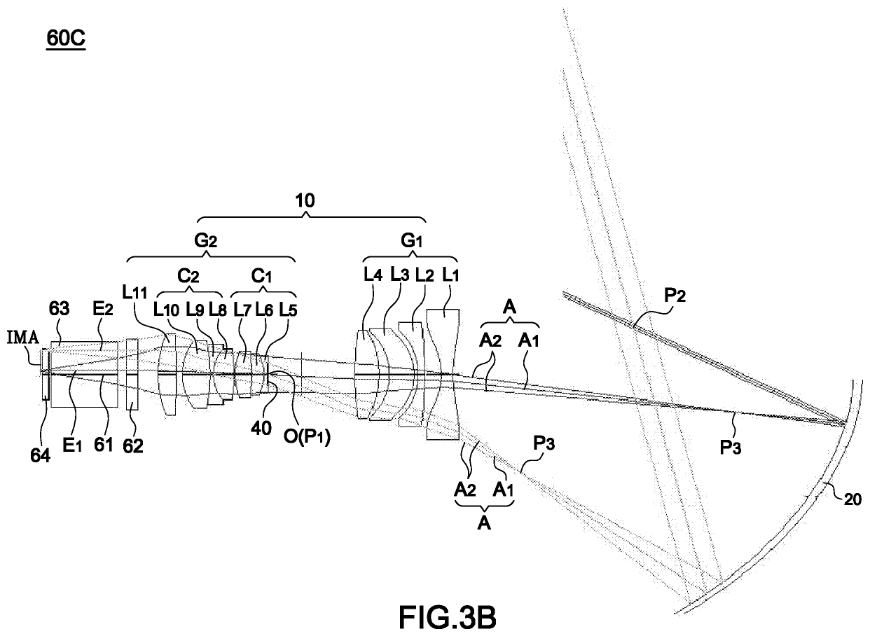

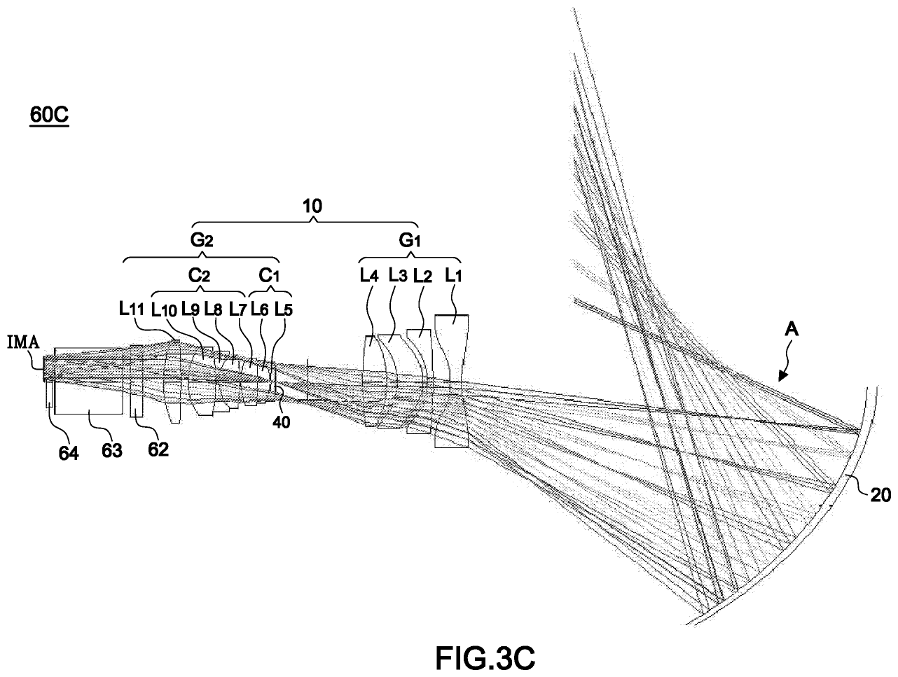

Referring to the FIGS. 3A-3C, Table 5, Table 6 and Table 7, the projection optical system 60C of the third embodiment has the front group lens G₁ includes a first lens L₁, a second lens L₂, a third lens L₃ and a fourth lens L₄, the first lens L₁ and the third lens L₃ are aspheric lens; the two doublet of the rear group lens G₂ are formed by bonding a fifth lens L₅ and a sixth lens L₆ to form a first doublet C₁, and by bonding an eighth lens L₈, a ninth lens L₉ and a tenth lens L₁₀ to form a second doublet C₂, and the seventh lens L₇ are aspheric lens, the seventh lens L₇ can also be an independent lens, or the seventh lens L₇ can be bonded with the sixth lens L₆ to make the fifth lens L₅, the sixth lens L₆ and the seventh lens L₇ form a first doublet C₁; the eleventh lens L₁₁ is the last lens, but the present invention is not limited to such application.

TABLE 5

| | | | Refractive | Abbe |
|---|---|---|---|---|
| | | Thickness | index | Number |
| Surface | Radius (mm) | (mm) | (Nd) | (Vd) |
| (MIRROR) | 31.24 | 69.00 | | |
| 1R₁ | −18.77 | 1.96 | 1.53 | 56.28 |
| 1R₂ | 14.62 | 2.94 | | |
| 2R₁ | 96.05 | 1.00 | 1.74 | 53.80 |
| 2R₂ | 10.86 | 0.75 | | |
| 3R₁ | 11.51 | 4.27 | 1.53 | 56.28 |
| 3R₂ | 12.83 | 1.83 | | |
| 4R₁ | 16.93 | 4.14 | 1.85 | 23.79 |
| 4R₂ | −55.42 | 14.81 | | |
| (APERTURE) | INF | 0.19 | | |
| 5R₁ | −59.26 | 0.64 | 1.81 | 40.08 |
| 6R₁ | 7.10 | 2.26 | 1.64 | 34.65 |
| 7R₁ | 45.28 | 2.75 | 1.52 | 64.07 |
| 7R₂ | −11.11 | 0.20 | | |
| 8R₁ | 30.88 | 3.51 | 1.50 | 81.59 |
| 9R₁ | −7.26 | 0.60 | 1.85 | 23.79 |
| 10R₁ | 27.94 | 4.81 | 1.50 | 81.59 |
| 10R₂ | −9.93 | 1.08 | | |
| 11R₁ | 139.96 | 3.10 | 1.92 | 18.90 |
| 11R₂ | −18.73 | 3.50 | | |

TABLE 6

| ASPH | 1R₁ | 1R₂ | 3R₁ | 3R₂ | 7R₁ | 7R₂ |
|---|---|---|---|---|---|---|
| Radius | −18.77 | 14.62 | 11.51 | 12.83 | 45.28 | −11.11 |
| Conic | 0.00 | 0.79 | 0.00 | 0.00 | 0.00 | 4.70 |
| 4TH | 4.21E−04 | 5.86E−04 | 1.05E−03 | 6.67E−04 | 0.00E+00 | 6.15E−04 |
| 6TH | −6.37E−06 | −7.49E−06 | −2.45E−05 | −1.08E−05 | 0.00E+00 | −3.34E−05 |
| 8TH | 8.42E−08 | −4.18E−07 | 2.58E−07 | 1.77E−07 | 0.00E+00 | 1.27E−05 |
| 10th | −7.97E−10 | 1.19E−08 | −2.88E−09 | −5.93E−09 | 0.00E+00 | −1.77E−06 |
| 12th | 5.07E−12 | −1.38E−10 | 3.99E−11 | 1.07E−10 | 0.00E+00 | 1.41E−07 |
| 14th | −1.88E−14 | 7.87E−13 | −4.16E−13 | −9.26E−13 | 0.00E+00 | −5.76E−09 |
| 16th | 3.04E−17 | −1.83E−15 | 1.86E−15 | 3.29E−15 | 0.00E+00 | 9.87E−11 |

TABLE 7

| ASPH | MIRROR |
|---|---|
| Radius | 31.24 |
| Normalized | 1.00 |
| radius | |
| Conic | −1.03 |
| 1TH | 0.00E+00 |
| 2TH | 3.38E−04 |
| 3TH | 5.83E−06 |
| 4TH | −1.75E−06 |
| 5TH | 1.55E−09 |
| 6TH | 2.17E−09 |
| 7TH | −2.05E−12 |
| 8TH | −1.56E−12 |
| 9TH | 1.21E−15 |
| 10TH | 9.21E−16 |
| 11TH | −2.52E−19 |
| 12th | −3.00E−19 |
| 13th | −1.50E−22 |
| 14th | 4.41E−23 |
| 15th | 1.14E−26 |
| 16th | 1.02E−27 |

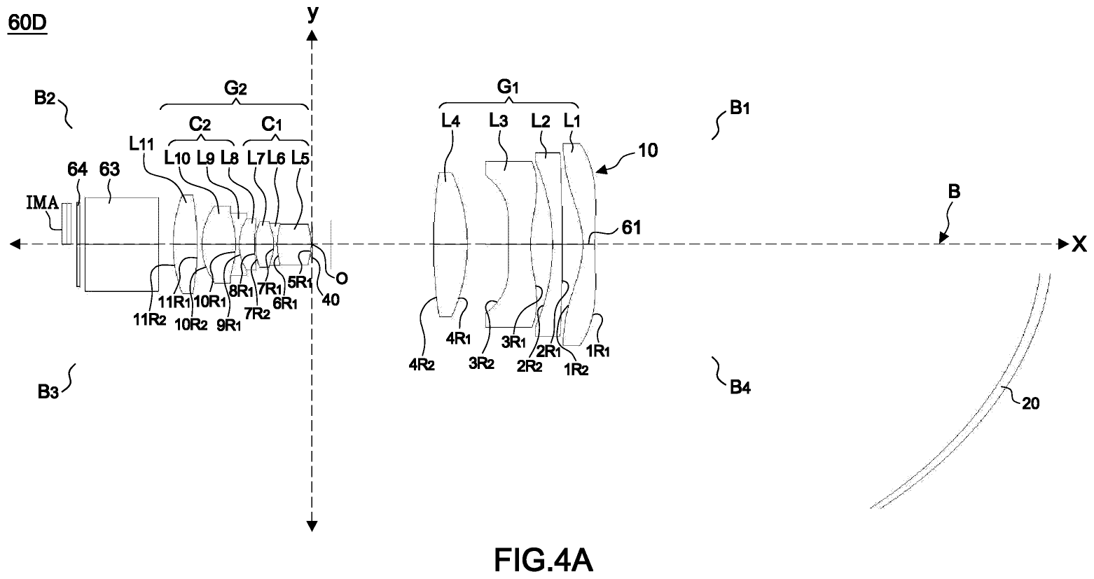

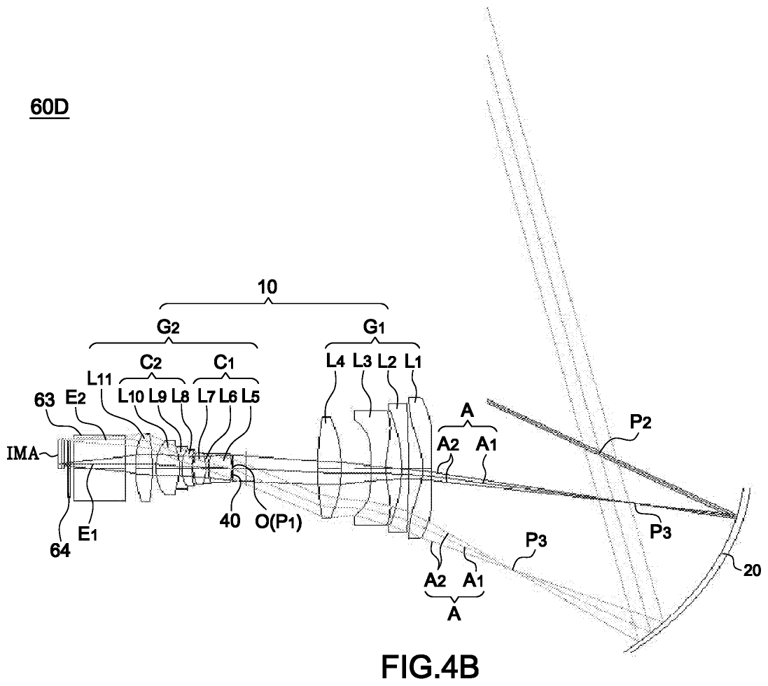

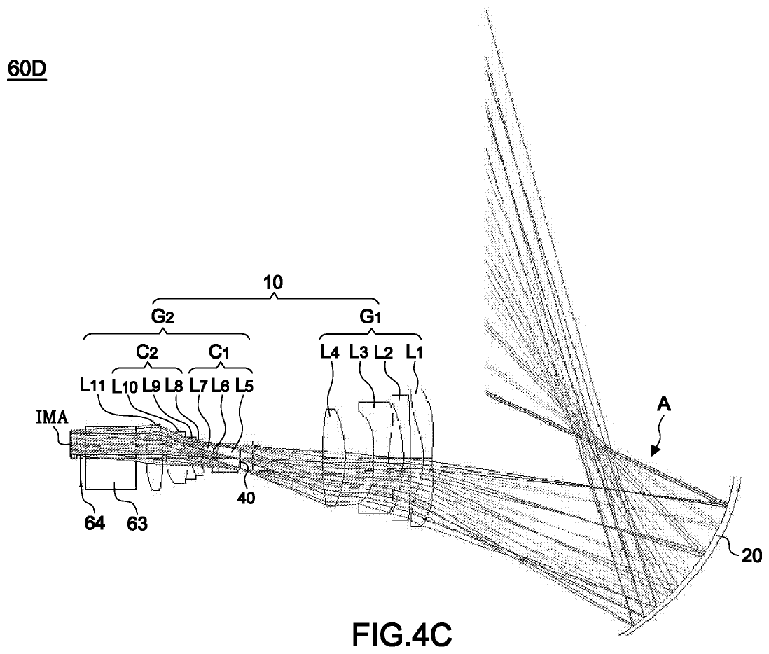

Referring to the FIGS. 4A-4C, Table 8 and Table 9, the projection optical system 60D of the fourth embodiment has the front group lens G₁ includes a first lens L₁, a second lens L₂, a third lens L₃ and a fourth lens L₄, the first lens L₁ and the third lens L₃ are aspheric lens; the two doublet of the rear group lens G₂ are formed by bonding a fifth lens L₅ and a sixth lens L₆ to form a first doublet C₁, and by bonding an eighth lens L₈, a ninth lens L₉ and a tenth lens L₁₀ to form a second doublet C₂, and the seventh lens L₇ are aspheric lens, the seventh lens L₇ can also be an independent lens, or the seventh lens L₇ can be bonded with the sixth lens L₆ to make the fifth lens L₅, the sixth lens L₆ and the seventh lens L₇ form a first doublet C₁; the eleventh lens L₁₁ is the last lens, but the present invention is not limited to such application.

TABLE 8

| | | | Refractive | Abbe |
|---|---|---|---|---|
| | | | index | Number |
| Surface | Radius | Thickness | (Nd) | (Vd) |
| (MIRROR) | 39.07 | 73.00 | | |
| 1R₁ | −78.23 | 2.00 | 1.51 | 56.32 |
| 1R₂ | 16.32 | 3.32 | | |
| 2R₁ | 323.43 | 1.60 | 1.85 | 23.79 |
| 2R₂ | 36.87 | 3.60 | | |
| 3R₁ | −19.75 | 3.56 | 1.51 | 56.32 |
| 3R₂ | −178.17 | 6.80 | | |
| 4R₁ | 30.87 | 5.50 | 1.85 | 23.79 |
| 4R₂ | −81.78 | 19.83 | | |
| (APERTURE) | INF | 0.20 | | |
| 5R₁ | 12.20 | 5.50 | 1.65 | 33.84 |
| 6R₁ | −12.20 | 0.60 | 1.83 | 37.23 |
| 7R₁ | 9.74 | 2.93 | 1.52 | 64.05 |
| 7R₂ | −10.96 | 0.20 | | |
| 8R₁ | −22.91 | 2.47 | 1.50 | 81.59 |
| 9R₁ | −8.54 | 0.60 | 1.85 | 23.79 |
| 10R₁ | 17.07 | 5.48 | 1.50 | 81.59 |
| 10R₂ | −11.29 | 0.75 | | |
| 11R₁ | 48.44 | 3.95 | 1.92 | 18.90 |
| 11R₂ | −24.43 | 2.40 | | |

TABLE 9

| ASPH | MIRROR | 1R₁ | 1R₂ | 3R₁ | 3R₂ | 7R₁ | 7R₂ |
|---|---|---|---|---|---|---|---|
| Radius | 39.07 | −78.23 | 16.32 | −19.75 | −178.17 | 9.74 | −10.96 |
| Conic | −0.92 | 0.00 | −1.94 | 0.00 | 0.00 | 0.00 | 1.92 |
| 4TH | −5.86E−07 | 1.04E−04 | −2.69E−05 | 2.38E−04 | 2.44E−04 | 0.00E+00 | 3.94E−04 |
| 6TH | 1.22E−09 | −5.68E−07 | −8.41E−07 | −1.22E−06 | −3.50E−08 | 0.00E+00 | 1.16E−06 |
| 8TH | −1.06E−12 | 3.22E−09 | 6.98E−09 | 9.13E−09 | −7.08E−09 | 0.00E+00 | 1.14E−06 |
| 10th | 6.42E−16 | −1.16E−11 | −2.64E−11 | −5.01E−11 | 1.33E−10 | 0.00E+00 | −2.27E−07 |
| 12th | −2.02E−19 | 2.18E−14 | 5.09E−14 | 1.68E−13 | −1.12E−12 | 0.00E+00 | 2.23E−08 |
| 14th | 2.71E−23 | −1.53E−17 | −3.85E−17 | −3.30E−16 | 4.17E−15 | 0.00E+00 | −1.07E−09 |
| 16th | 0.00E+00 | 0.00E+00 | 0.00E+00 | 3.27E−19 | −5.80E−18 | 0.00E+00 | 2.01E−11 |

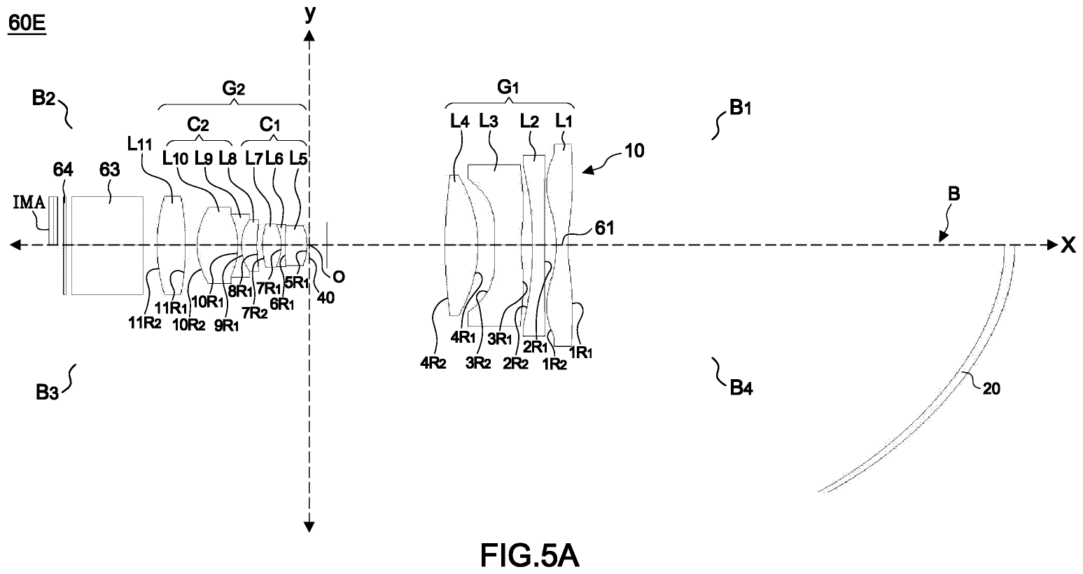

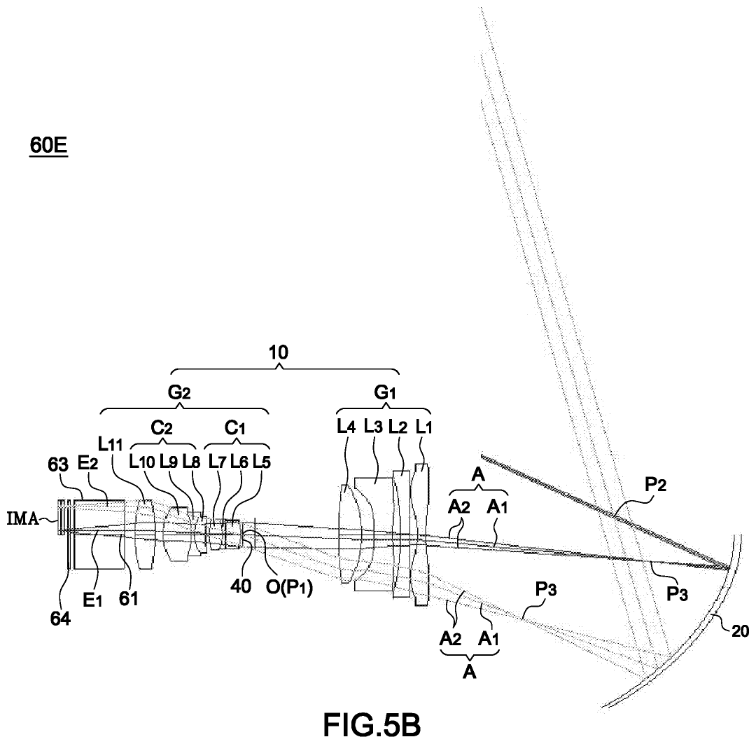

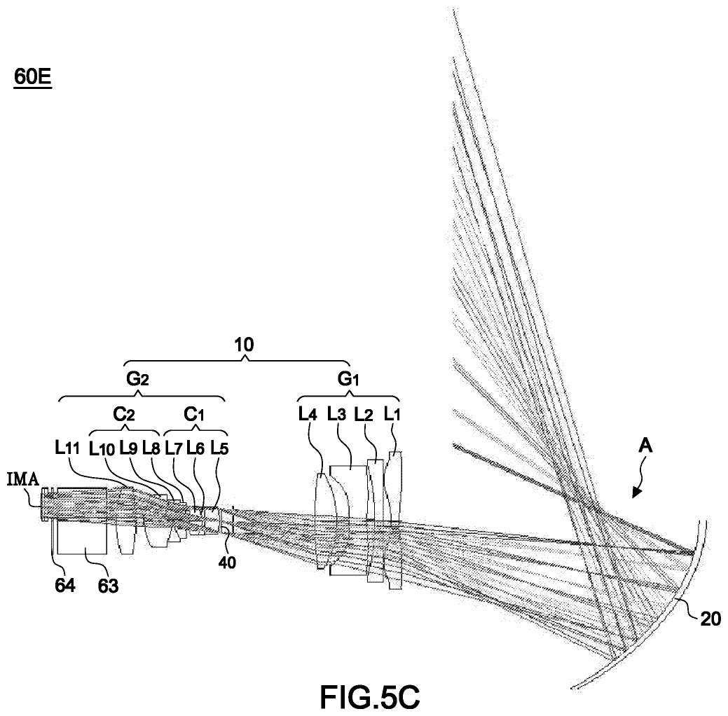

Referring to the FIGS. 5A-5C, Table 10 and Table 11, the projection optical system 60E of the fifth embodiment has the front group lens G₁ includes a first lens L₁, a second lens L₂, a third lens L₃ and a fourth lens L₄, the first lens L₁ and the third lens L₃ are aspheric lens; the two doublet of the rear group lens G₂ are formed by bonding a fifth lens L₅ and a sixth lens L₆ to form a first doublet C₁, and by bonding an eighth lens L₈, a ninth lens L₉ and a tenth lens L₁₀ to form a second doublet C₂, and the seventh lens L₇ are aspheric lens, the seventh lens L₇ can also be an independent lens, or the seventh lens L₇ can be bonded with the sixth lens L₆ to make the fifth lens L₅, the sixth lens L₆ and the seventh lens L₇ form a first doublet C₁; the eleventh lens L₁₁ is the last lens, but the present invention is not limited to such application.

TABLE 10

| | | | Refractive | Abbe |
|---|---|---|---|---|
| | | | index | Number |
| Surface | Radius | Thickness | (Nd) | (Vd) |
| (MIRROR) | 30.09 | 73.00 | | |
| 1R₁ | −29.42 | 2.00 | 1.51 | 56.32 |
| 1R₂ | 22.41 | 1.96 | | |
| 2R₁ | −778.80 | 2.00 | 1.80 | 25.63 |
| 2R₂ | 62.05 | 1.94 | | |
| 3R₁ | −20.64 | 4.37 | 1.51 | 56.32 |
| 3R₂ | −347.91 | 2.86 | | |
| 4R₁ | 24.77 | 5.50 | 1.84 | 29.82 |
| 4R₂ | −91.22 | 22.74 | | |
| (APERTURE) | INF | 0.44 | | |
| 5R₁ | 10.39 | 3.66 | 1.68 | 29.42 |
| 6R₁ | −35.98 | 0.60 | 1.83 | 43.03 |
| 7R₁ | 7.96 | 3.11 | 1.52 | 64.05 |
| 7R₂ | −14.56 | 0.95 | | |
| 8R₁ | −33.55 | 2.64 | 1.50 | 81.59 |
| 9R₁ | −8.18 | 0.60 | 1.85 | 23.78 |
| 10R₁ | 13.34 | 6.79 | 1.50 | 81.59 |
| 10R₂ | −12.57 | 1.95 | | |
| 11R₁ | 45.38 | 4.78 | 1.92 | 18.90 |
| 11R₂ | −30.43 | 2.40 | | |

TABLE 11

| ASPH | MIRROR | 1R₁ | 1R₂ | 3R₁ | 3R₂ | 7R₁ | 7R₂ |
|---|---|---|---|---|---|---|---|
| Radius | 30.09 | −29.42 | 22.41 | −20.64 | −347.91 | 7.96 | −14.56 |
| Conic | −1.04 | 0.00 | −2.16 | 0.00 | 0.00 | 0.00 | 2.71 |
| 4TH | −2.34E−06 | 1.81E−04 | 1.58E−04 | 6.97E−04 | 4.72E−04 | 0.00E+00 | 2.46E−04 |
| 6TH | 4.43E−09 | −1.12E−06 | −3.83E−06 | −1.15E−05 | −3.98E−06 | 0.00E+00 | −7.50E−07 |
| 8TH | −5.00E−12 | 5.40E−09 | 2.39E−08 | 1.39E−07 | 1.73E−08 | 0.00E+00 | 6.93E−07 |
| 10th | 3.76E−15 | −1.90E−11 | −7.03E−11 | −1.13E−09 | 4.13E−10 | 0.00E+00 | −1.19E−07 |
| 12th | −1.52E−18 | 4.21E−14 | 9.35E−14 | 5.76E−12 | −6.77E−12 | 0.00E+00 | 1.02E−08 |
| 14th | 2.57E−22 | −4.17E−17 | −3.63E−17 | −1.62E−14 | 3.83E−14 | 0.00E+00 | −4.31E−10 |
| 16th | 0.00E+00 | 0.00E+00 | 0.00E+00 | 1.92E−17 | −7.83E−17 | 0.00E+00 | 7.23E−12 |

With the features disclosed above, the 1-5 embodiment of the projection optical system 60A-60E, Table 12 has summarized the focal length of the first lens L1, the focal length of the third lens L3,the focal length of the reflector 20, the focal length of the lens group 10, the width W of the image 30, the projection distance T, the F value of the projection optical system 60A-60E, the displacement d, the short side h of the image source IMA, and the upper and lower components (X1, Y1, X2, Y2, X3, Y3 ) in order to adjust to a certain matching range, thereby improve the quality of the image 30.

TABLE 12

| | Embodiment | Embodiment | Embodiment | Embodiment | Embodiment |
|---|---|---|---|---|---|
| | 1 | 2 | 3 | 4 | 5 |
| Focal length of L1 | −15.58 | −15.58 | −15.25 | −26.11 | −24.45 |
| Focal length of L3 | −180 | −180 | 100 | −43.59 | −42.92 |
| Focal length of | 14.76 | 14.76 | 15.30 | 19.54 | 15.04 |
| reflector | | | | | |
| Focal length of lens | 5.49 | 5.68 | 5.10 | 6.51 | 9.32 |
| group | | | | | |
| width of the image | 1438.97 | 664.14 | 1328.281 | 1438.97 | 1438.97 |
| projection distance | 360 | 180 | 330 | 360 | 360 |
| F value of the | 1.8 | 1.8 | 1.8 | 2.6 | 3.13 |
| projection optical | | | | | |
| system | | | | | |
| displacement | 2.04 | 2.04 | 2.04 | 3.23 | 3.23 |
| the short side h of | 2.92 | 2.92 | 2.92 | 4.61 | 4.61 |
| the image source | | | | | |
| upper and lower | −4.83 | −4.75 | −5.12 | −7.10 | −5.05 |
| components (X₁) | | | | | |
| upper and lower | −4.74 | −4.66 | −5.16 | −6.05 | −4.51 |
| components (Y₁) | | | | | |
| upper and lower | −16.87 | −16.60 | −18.19 | −22.82 | −16.69 |
| components (X₂) | | | | | |
| upper and lower | −15.91 | −15.64 | −17.56 | −19.14 | −14.58 |
| components (Y₂) | | | | | |
| upper and lower | −26.74 | −26.31 | −29.65 | −31.67 | −24.28 |
| components (X₃) | | | | | |
| upper and lower | −23.58 | −23.36 | −26.42 | −26.85 | −21.10 |
| components (Y₃) | | | | | |

Although particular embodiment of the invention has been described in detail for purposes of illustration, various modifications and enhancements may be made without departing from the spirit and scope of the invention. Accordingly, the invention is not to be limited except by the appended claims.

What is claimed is:

1. A projection optical system, comprising:
an image source;
a lens group arranged at the lateral side of the image source;
a reflector arranged at the lateral side of the lens group;
an image, the lens group and the reflector form multiple optical paths between the image and image source, each optical path has a chief ray and a marginal ray; and
an aperture arranged inside the lens group and the center of the aperture is defined as an origin, define the axial direction as X axis and the radial direction as Y axis to form a rectangular coordinate system, the rectangular coordinate system has a first quadrant, a second quadrant, a third quadrant and a fourth quadrant, and the projection optical system has an optical axis which coincided with the X axis making the chief ray of one of the optical paths forms a chief ray of a paraxial image height at the part where image source be near to the optical axis, the chief ray of another one of the optical paths forms a marginal ray of an off-axis image height at the part where image source be far from the optical axis;
whereby when the image source and the image are located in the second quadrant and the reflector is located in the fourth quadrant, the chief ray of the paraxial image height intersect withs the chief ray of the off-axis image height intersect, then sequentially forming a first point and a second point, the first point located at the origin and the second point is located in the first quadrant, and the chef ray of the optical path intersects with the marginal ray of the optical path, and sequentially forming a third point and a fourth point, the third point located at the fourth quadrant and the fourth point is located in the second quadrant.

2. The projection optical system as claimed in claim 1, wherein the lens group can be divided into a front group lens and a rear group lens, the front group lens is close to the reflector side, and the rear group lens is close to the image source side, the distance between the front group lens and the rear group lens is the longest lens distance in the lens group.

3. The projection optical system as claimed in claim 2, wherein the front group lens includes at least two aspheric lens, and at least one of the aspheric lens is a negative lens.

4. The projection optical system as claimed in claim 2, wherein the rear group lens includes at least two doublet and an aspheric lens, the aspheric lens can be a double-sided aspheric independent lens, or the aspheric lens can be one side aspheric and one spherical, the aspheric lens and the spherical can be bonding to form a doublet.

5. The projection optical system as claimed in claim 2, wherein the Abbe number of the last lens of the rear group lens is 17-24 and is close to the image source side.

6. The projection optical system as claimed in claim 1, wherein the focal length of the reflector is F1 and the focal length of the lens group is F2, and the projection optical system meets the 11.5<F1/F2<3.2.

7. The projection optical system as claimed in claim 1, wherein the width of the image is set as W and the project distance from the reflector to the image is set as T, and conforms to the conditional formula of the projection ratio of the projection optical system: T/W<0.275.

8. The projection optical system as claimed in claim 1, wherein the F value of the projection optical system is 1.6-3.2.

9. The projection optical system as claimed in claim 1, wherein the displacement of the center point of the image source corresponding to the optical axis is define as d, and short side of the image source is defined as h, and fits the condition: 2d/h>120%.

10. The projection optical system as claimed in claim 1, wherein take the center of the image source as the base point as a reference to get locations of the upper point, the lower point, the left point, the right point, an upper left point, the upper right point, the lower left point and the lower right point, at the boundary of the image source, and when the image source is above the optical axis, at the midpoint position between the lens group and the reflector, the chief ray of each optical path forms a chief ray of the central optical path, a chief ray of the upper optical path, a chief ray of the lower optical path, a chief ray of the left optical path, a chief ray of the right optical path, a chief ray of the upper left optical path, a chief ray of the upper right optical path, a chief ray of the lower left optical path, a chief ray of the lower right optical path, and the up and down component of the distance from the chief ray of the central optical path to the optical axis is set as X₂, and the up and down component of the distance from the chief ray of the upper optical path to the optical axis is set as X₃, the up and down component of the distance from the chief ray of the lower optical path to the optical axis is set as X₁, the up and down component of the distance from the chief ray of the left optical path to the optical axis is set as Y₂, the up and down component of the distance from the chief ray of the right optical path to the optical axis is set as Y₂, the up and down component of the distance from the chief ray of the upper left optical path to the optical axis is set as Y₃, the up and down component of the distance from the chief ray of the upper right optical path to the optical axis is set as Y₃, the up and down component of the distance from the chief ray of the lower left optical path to the optical axis is set as Y₁, the up and down component of the distance from the chief ray of the lower right optical path to the optical axis is set as Y₁, and meet the following conditions: 0.9*|Y1|≤|X1|≤1.2*|Y1|; |X2|>|Y2|; |X3|>|Y3|.

11. The projection optical system as claimed in claim 1, wherein between the reflector and the image include at least an optical element for deflecting the optical path or correcting aberrations.
